(19) United States
(12) Patent Application Publication
(10) Pub. No.: US 2019/0283243 A1
(43) Pub. Date: Sep. 19, 2019

(54) ROBOT

(71) Applicant: Fanuc Corporation, Yamanashi (JP)

(72) Inventor: Tadatoki Shimada, Yamanashi (JP)

(73) Assignee: Fanuc Corporation, Yamanashi (JP)

(21) Appl. No.: 16/284,155

(22) Filed: Feb. 25, 2019

(30) Foreign Application Priority Data
Mar. 13, 2018 (JP) 2018-044888

(51) Int. Cl. B25J 9/12; B25J 18/00; B25J 9/14

(52) U.S. Cl. CPC B25J 9/12; B25J 9/14; B25J 18/00

(57) ABSTRACT

Provided is a robot capable of facilitating an adjusting operation of a length of a cable contained within an arm member. This robot is provided with an arm member and a cable-length adjustment member configured to adjust the length of a cable contained within the arm member. The cable-length adjustment member is removably attached to the arm member.

### CROSS-REFERENCE TO RELATED APPLICATIONS

This application is based on and claims priority to Japanese Patent Application No. 2018044888 filed on Mar. 13, 2018, the content of which is incorporated herein by reference in its entirety.

### TECHNICAL FIELD

The present invention relates to a robot.

### BACKGROUND ART

There is known a robot having a cable-length adjustment mechanism for adjusting a length of a cable contained within an arm (cf. PTL 1). For example, a cable for sending electrical power and signals to a hand is contained within the arm, and a cable-length adjustment mechanism is provided within an arm member that constitutes a base-end side of the arm. The cable-length adjustment mechanism includes a plurality of pulleys that are movable in a vertical direction, and the cable is wound around each of the pulleys. Therefore, the length of the cable within the arm is adjusted by adjusting a position of each pulley in the vertical direction.

### CITATION LIST

### Patent Literature

### {PTL 1}

Japanese Unexamined Patent Application, Publication No. 2016-87718

### SUMMARY OF INVENTION

A robot according to one aspect of the present disclosure is provided with: an arm member; and a cable-length adjustment member configured to adjust length of a cable contained within the arm member, wherein the cable-length adjustment member is removably attached to the arm member.

### BRIEF DESCRIPTION OF DRAWINGS

FIG. 1 is a schematic configurational view of a robot according to a first embodiment of the present invention.

FIG. 2 is a block diagram of a controller of the robot according to the first embodiment.

FIG. 3 is a diagram illustrating a use state of a cable-length adjustment member according to the first embodiment.

FIG. 4 is a side view of the cable-length adjustment member according to the first embodiment.

FIG. 5 is a cross-sectional view illustrating a modified example of the cable-length adjustment member according to the first embodiment.

FIG. 6 is a schematic configurational view of a robot according to a second embodiment of the present invention.

FIG. 7 is a diagram illustrating a use state of a cable-length adjustment member according to the second embodiment.

FIG. 8 is a side view of the cable-length adjustment member according to the second embodiment.

FIG. 9 is a cross-sectional view illustrating a modified example of the cable-length adjustment member according to the second embodiment.

FIG. 10 is a diagram illustrating a use state of the cable-length adjustment member of a modified example according to the first embodiment.

### DESCRIPTION OF EMBODIMENTS

Hereinafter, a robot 1 according to a first embodiment of the present invention will be described with reference to the drawings.

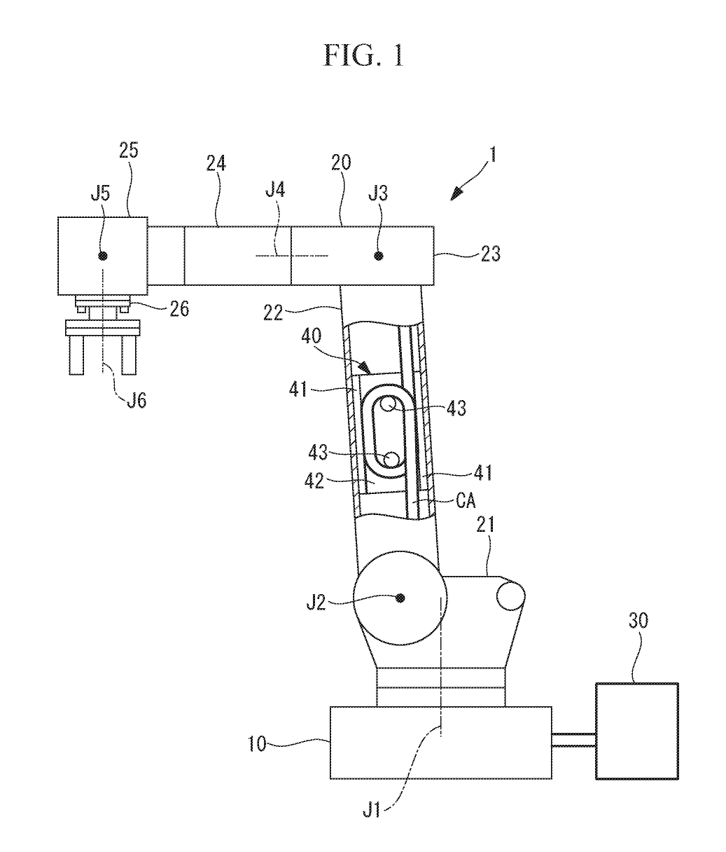

The robot 1 of this embodiment is of a vertically articulated type, and includes an arm 20 and a controller 30 as illustrated in FIG. 1.

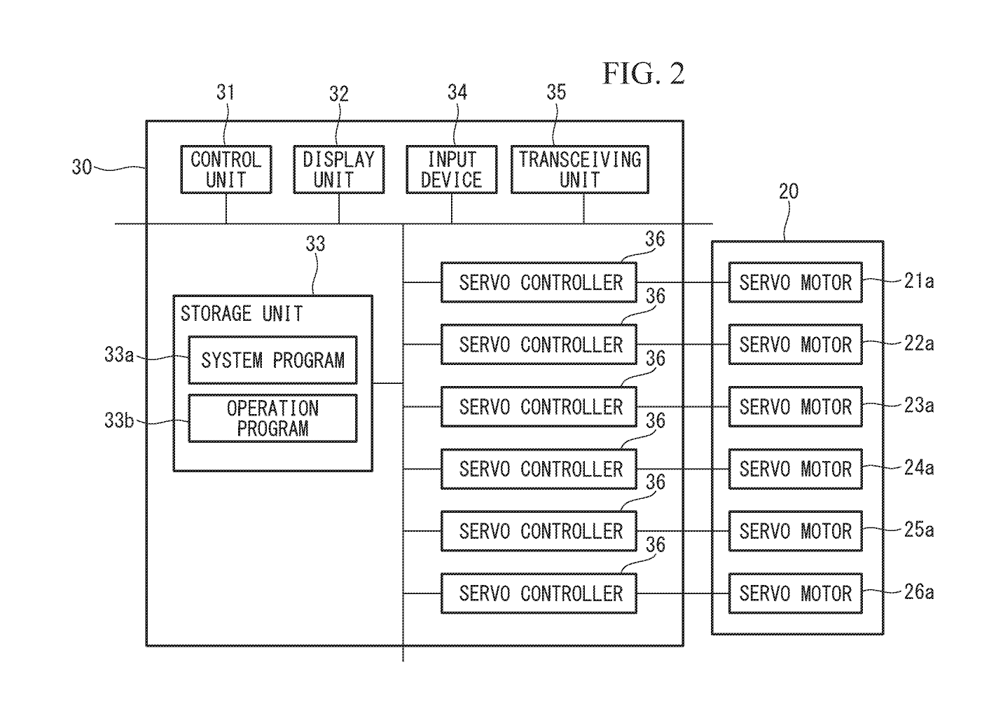

The arm 20 includes a plurality of arm members 21, 22, 23, 24, 25, and 26 and a plurality of joints. The arm 20 also includes a plurality of servo motors 21a, 22a, 23a, 24a, 25a, and 26a that respectively drive the plurality of joints (see FIG. 2). Examples of the servo motors 21a-26a that may be used include servo motors of various types such as rotary motors and linier motors. Each of the servo motors 21a-26a includes an operational position detecting device for detecting its operational position and operational speed. One example of the operational position detecting device is an encoder. Detected values of the operational position detecting devices are transmitted to the controller 30. Here, the number of the arm members may be 5 or smaller, or may be 7 or greater.

In this embodiment, a base-end side of the arm member 21 is supported by a base portion 10, and the arm member 21 is driven by the servo motor 21a to rotate about a J1 axis line with respect to the base portion 10. A base-end side of the arm member 22 is supported by a tip-end side of the arm member 21, and the arm member 22 is driven by the servo motor 22a to rotate about a J2 axis line. A base-end side of the arm member 23 is supported by a tip-end side of the arm member 22, and the arm member 23 is driven by the servo motor 23a to rotate about a J3 axis line.

Further, a base-end side of the arm member 24 is supported by a tip-end side of the arm member 23, and the arm member 24 is driven by the servo motor 24a to rotate about a J4 axis line. A base-end side or a middle section of the arm member 25 is supported by a tip-end side of the arm member 24, and the arm member 25 is driven by the servo motor 25a to rotate about a J5 axis line. A base-end side of the arm member 26 is supported by a tip-end side of the arm member 25, and the arm member 26 is driven by the servo motor 26a to rotate about a J6 axis line.

In this embodiment, the arm member 22, the arm member 23, and the arm member 25 are configured such that their one ends move along corresponding predetermined trajectories centering the respective base-end sides or the middle section. On the other hand, axis lines extending from the base-end sides to the tip-end sides of the arm member 21, the arm member 24, and the arm member 26 are respectively along the J1 axis line, the J4 axis line, and the J6 axis line. In other words, each of the arm member 21, the arm member 24, and the arm member 26 rotates about its axis line that extends from the corresponding base-end side to the corresponding tip-end side. In this embodiment, the movement of the arm members 21-26 respectively about the J1 axis line to the J6 axis line is referred to as rotation.

As illustrated in FIG. 2, the controller 30 includes a control unit 31 having a processor or the like, a display unit 32, a storage unit 33 having a non-volatile storage, a ROM, a RAM, or the like, an input device 34 such as a keyboard, a touch-screen, or an operation panel, a transceiving unit 35 for transmitting and receiving signals, and servo controllers 36 respectively connected to the servo motors 21a-26a. The input device 34 and the transceiving unit 35 serve as an input unit. The storage unit 33 stores a system program 33a and an operation program 33b, and the control unit 31 controls the servo motors 21a-26a based on the operation program 33b.

Within the arm 20, a cable CA including electrical power lines and signal lines for the servo motors 21a-26a is provided. The electrical power lines and the signal lines are flexible wiring members. When the electrical power lines and the signal lines are provided for the servo motors 21a-26a, respectively, a bundle of the electrical power lines and the signal lines is disposed within the arm 20. In this embodiment, the bundle of the electrical power lines and the signal lines is referred to as the cable CA. On the other hand, there is a case in which the electrical power lines and the signal lines for the servo motors 23a, 24a, 25a, and 26a constitute a single wiring member within the arm member 22. In this case, too, the wiring member within the arm member 22 is referred to as the cable CA. It should be noted that the cable CA is also used in order to connect the controller 30 with the arm 20.

In addition to the electrical power lines and the signal lines, there is a case in which a pipe or the like for supplying a fluid into a tool is provided. The flexible pipe itself can be the cable CA, or the flexible pipe can be disposed within the cable CA. There is also a case in which an elongated flexible wiring member of a different type is disposed within the arm 20.

The electrical power lines, the signal lines, the pipes, and the like are elongated flexible members, and in order to bend these at a small curvature radius, a considerable force is often required for the bending. In particular, when the cable CA constituted by a bundle of these lines and pipes, a greater force is required for the bending.

In this embodiment, there is a different robot having the arm member 22 of a different length as a variation of the robot 1. The different robot has the same configuration as the robot 1 other than that the arm member 22 of the different robot is longer than that of the robot 1 by several tens of centimeters. Therefore, the cable CA of the same type is employed for both of the robot 1 and the different robot. It should be noted that there may be more than one type of the different robot.

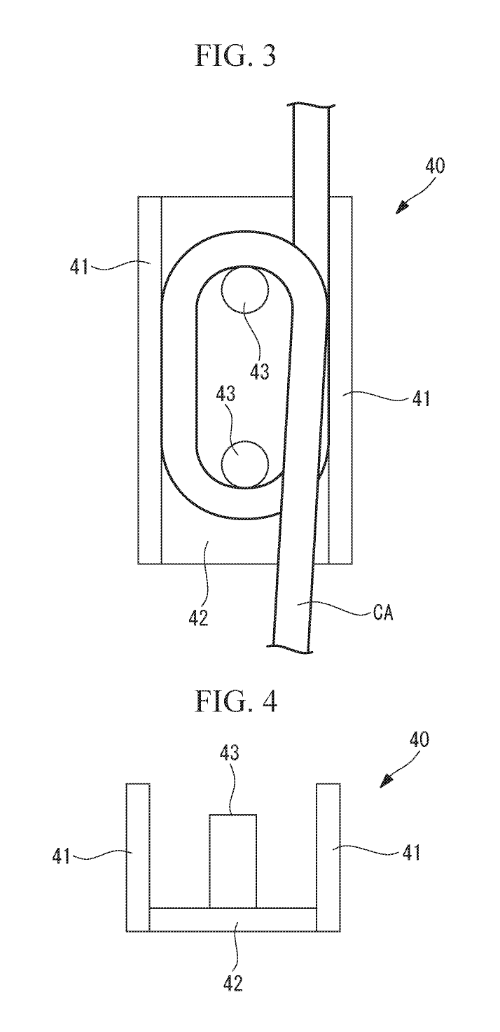

As described above, the arm member 22 of the different robot is longer than that of the robot 1, and therefore the cable CA of the different robot is also longer that of the robot 1 by the difference between the lengths of the arm member 22. In this embodiment, as illustrated in FIG. 1 and FIG. 3, the length of the cable CA is adjusted by a cable-length adjustment member 40 within the arm member 22.

The cable-length adjustment member 40 is made of a metallic material, a plastic material, or the like. The cable-length adjustment member 40 includes a pair of walls 41 that face each other, and a connecting member 42 that connects the pair of walls 41. One example of the connecting member 42 is a square-shaped plate member. The walls 41 are provided respectively on both ends of the connecting member 42 either in a longer direction or in a shorter direction, and the pair of walls 41 extend toward one side of a through-thickness direction of the connecting member 42. In this embodiment, the walls 41 are provided respectively on the both ends of the shorter direction of the connecting member 42.

As illustrated in FIG. 3 and FIG. 4, two cylindrical pins 43 are attached to the connecting member 42, and the pins 43 extend toward the one side of the through-thickness direction of the connecting member 42.

The cable-length adjustment member 40 may be contained within the arm member 22. Further, when the cable-length adjustment member 40 is contained within the arm member 22, the cable-length adjustment member 40 is attached to the arm member 22. The cable-length adjustment member 40 may be attached to the arm member 22 by providing the arm member 22 with a shape that is complementary to the shape of the cable-length adjustment member 40. Further, the cable-length adjustment member 40 may be attached to the arm member 22 by bolts.

When the length of the cable CA is adjusted, the cable-length adjustment member 40 is first removed from the arm member 22. Then, a part of the cable CA is wound within the cable-length adjustment member 40. For example, as illustrated in FIG. 1 and FIG. 3, the part of the cable CA is wound around the two pins 43. At this time, an entire part of the cable CA may be removed from the arm 20, or part of the cable CA may be disposed within the arm 20.

As described above, a large force is required to bend the cable CA. Further, in order to adjust a length by several tens of centimeters, the cable CA is required to be wound at a curvature radius from several centimeters to more than ten centimeters. In this case, a larger force is required to bend the cable CA.

On the other hand, a restoring force to the bending is generated in the bent cable CA. In other words, the bent cable CA attempts to return to a direction opposite to a direction of the bending.

In other words, the cable CA wound around the two pins 43 is deformed toward a restoring direction. Here, the two pins 43 are disposed between the pair of walls 41, and the pair of walls 41 face each other. Therefore, deformation of the cable CA in the restoring direction is restricted by the pair of walls 41. In this manner, as inflation of the cable CA is restricted by the pair of walls 41, it is possible to easily contain the cable CA along with the cable-length adjustment member 40 within the arm member 22 after adjustment of the length of the cable CA is finished. It should be noted that the cable-length adjustment member 40 is attached to the arm member 22 in an inverse order.

As described above, in this embodiment, the cable-length adjustment member 40 may be removed from the arm member 22. Therefore, it is possible to adjust the length of the cable CA by the cable-length adjustment member 40, in a state in which the cable-length adjustment member 40 is removed from the arm member 22. Accordingly, even when the cable CA is thick and thus it is not easy to bend the cable CA, it is possible to facilitate an adjusting operation of the length of the cable CA as compared to a case in which the cable CA is bent within the arm member 22.

By employing this configuration, the cable CA of the same length may be used for the different robot having the arm member 22 of different lengths but using the same electrical power lines and the same signal lines. In other words, it is possible to determine whether to use the cable-length adjustment member 40 or not according to the type of the robot. Moreover, it is possible to change an amount of adjustment of the cable-length adjustment member 40 according to the type of the robot.

Further, in this embodiment, the cable-length adjustment member 40 contains the bent cable CA, and includes the pair of walls 41 that restrict deformation of the cable CA in the restoring direction for restoring the bending.

In other words, the pair of walls 41 restrict deformation of the cable CA in the restoring direction. Therefore, even when the cable CA is required to be bent at a curvature radius from several centimeters to more than ten centimeters in order to adjust the length by more than ten centimeters to several tens of centimeters, it is possible to facilitate an operation for the bending by the presence of the pair of walls 41.

Further, in this embodiment, the cable-length adjustment member 40 is contained within the arm member 22.

In this embodiment, as the pair of walls 41 are employed, the cable CA may be easily bent within the cable-length adjustment member 40. It is also possible to contain the cable-length adjustment member 40 within the arm member 22 after the cable CA within the cable-length adjustment member 40 is bent outside the arm member 22. This configuration is advantageous in order to facilitate the adjusting operation of the length of the cable CA.

Further, in this embodiment, the cable-length adjustment member 40 includes the connecting member 42 that connects the pair of walls 41 and the pins 43 that are provided for the connecting member 42 and around which the cable CA is wound.

According to this configuration, there are the pins 43 around which the cable CA is wound, and therefore the adjusting operation of the length of the cable CA may be facilitated as compared to a case in which there is no pin 43. It should be noted that the number of the pins 43 may be less than two or more than two.

It should be noted that, in this embodiment, the pins 43 are rotatable with respect to the connecting member 42. For example, two spindles 43a are fixed to the connecting member 42, and the pins 43 are respectively supported by the spindles 43a using bearings. With this, each of the pins 43 is rotatable around its central axis line.

If there are the pins 43 fixed between the pair of walls 41 when the cable CA is contained between the pair of walls 41 while the cable CA is bent, the pins 43 often serve a resisting force during a containing operation. This tendency is shown, in particular, when the cable CA is thick and therefore it is not easy to bend the cable CA. If the pins 43 are rotatable, it is possible to reduce the resisting force when the cable CA is contained between the pair of walls 41 while the cable CA is bent.

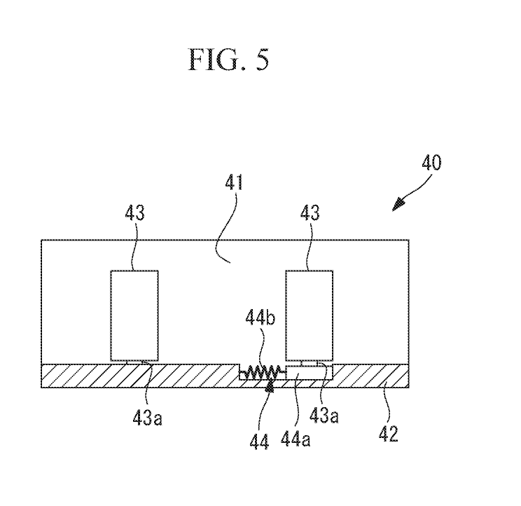

Here, as illustrated in FIG. 5, the cable-length adjustment member 40 may include a pin-interval adjustment mechanism 44 for adjusting an interval between the two pins 43. The pin-interval adjustment mechanism 44 shown in FIG. 5 includes a slider 44a to which the spindle 43a of one of the pins 43 is fixed, and a biasing member 44b such as a spring that biases the slider 44a in a direction away from the other of the pins 43. According to this configuration, if a force toward the other pin 43 is applied to the one pin 43 by the cable CA, the one pin 43 moves toward the other pin 43.

There is a case in which, after the cable-length adjustment member 40 is attached to the arm member 22, the length of the cable CA is slightly adjusted by pulling the cable CA disposed outside the cable-length adjustment member 40. In the configuration illustrated in FIG. 5, one of the two pins 43 is supported movably toward the other of the pins 43, and this configuration is advantageous in order to facilitate the slight adjustment.

Here, the pin-interval adjustment mechanism 44 may be provided for each of the two pins 43.

It should be noted that the cable-length adjustment member 40 may have a box shape. In other words, longitudinal walls may be provided respectively on the both ends of the connecting member 42 in the longitudinal direction, and the longitudinal walls may extend toward one side of the through-thickness direction of the connecting member 42. A cover may also be provided for closing tip-end sides of the pair of longitudinal walls and the pair of walls 41.

Hereinafter, a robot 2 according to a second embodiment of the present invention will be described with reference to the drawings.

In the second embodiment, the components which are similar to or the same as those in the first embodiment are denoted by the same reference symbols, and descriptions for the configurations, processes, and operations that are similar to or the same as those in the first embodiment shall be omitted. Further, the second embodiment may be modified similarly to the first embodiment. For example, the number of the arm members may be modified, and servo motors of various types may be used as the servo motors 21a-26a.

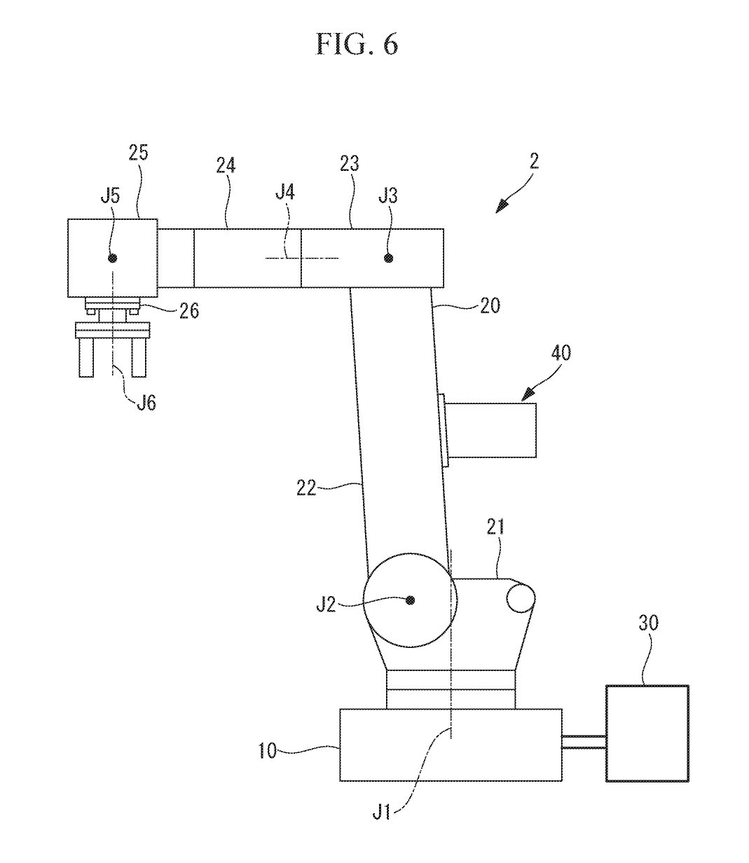

As illustrated in FIG. 6, the robot 2 of the second embodiment includes the cable-length adjustment member 40 attached at a predetermined position on an outer periphery surface of the arm member 22.

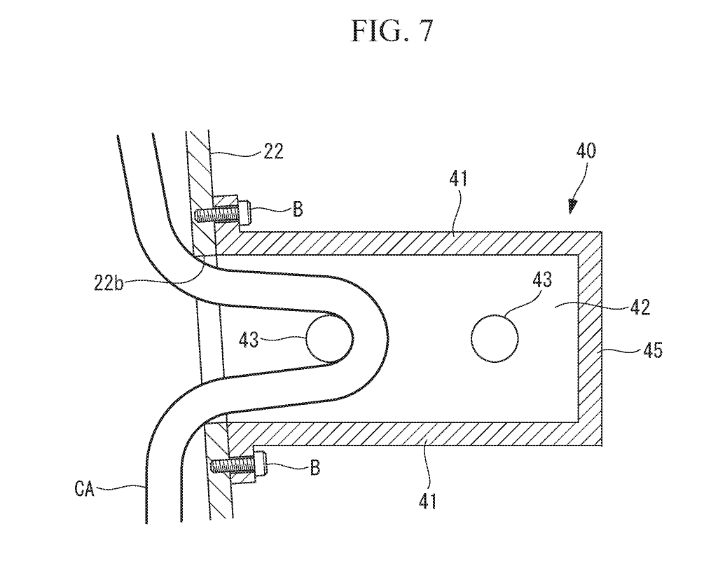

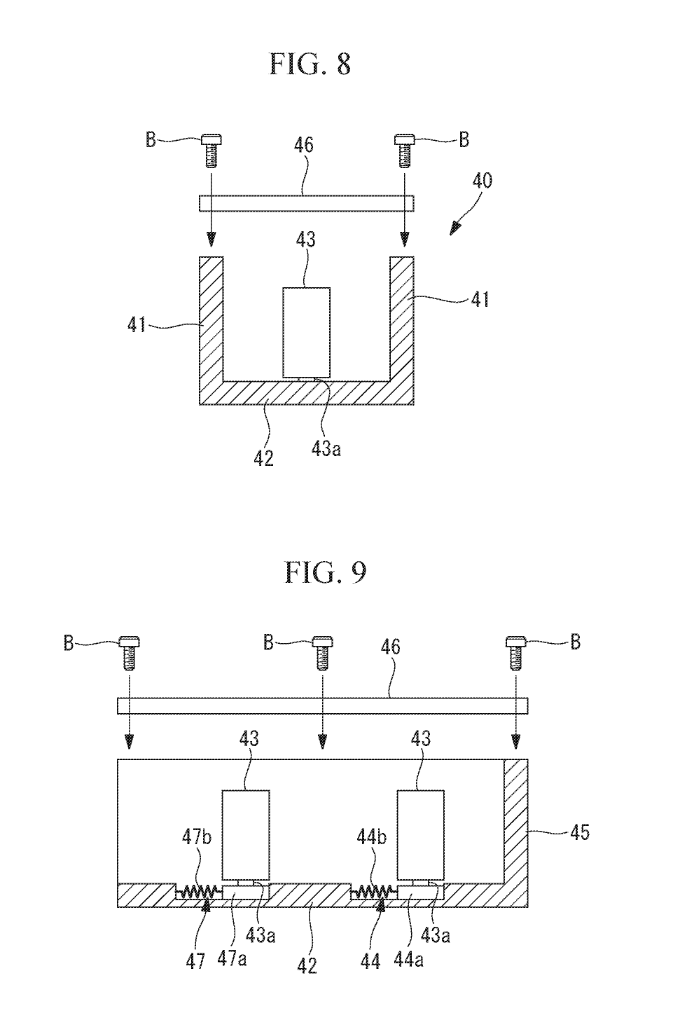

As illustrated in FIG. 7 and FIG. 8, the cable-length adjustment member 40 of the second embodiment includes the pair of walls 41, the connecting member 42, and the two pins 43, similarly to the first embodiment. In addition, the cable-length adjustment member 40 of the second embodiment includes an end wall 45 provided on one end of the connecting member 42 in the longer direction, and a cover 46.

The end wall 45 is provided on one end of the connecting member 42 in the longer direction, and extends toward one side of the through-thickness direction of the connecting member 42. The cover 46 is attached to a tip end portion of the wall 41, a tip end portion of the end wall 45, and the like by a plurality of bolts B. The two pins 43 are disposed between the attached cover 46 and the connecting member 42.

In a state in which the cover 46 is attached, the cable-length adjustment member 40 opens to the other side of the connecting member 42 in the longer direction.

The opening side of the cable-length adjustment member 40 is attached to the outer periphery surface of the arm member 22 by the plurality of bolts B.

At the predetermined position of the arm member 22 at which the cable-length adjustment member 40 is attached, a hole 22b that can be used for a wiring operation within the arm member 22 is provided. The size of the hole 22b is such that a human hand can get into the hole, and this allows a user of the robot 2 to perform the wiring operation within the arm member 22 through the hole 22b.

In order to adjust the length of the cable CA, as one example, the cable-length adjustment member 40 is removed from the arm member 22. Subsequently, a part of the cable CA is arranged within the cable-length adjustment member 40. For example, the part of the cable CA is wound around one of the two pins 43 in the state in which the cover 46 is removed. At this time, an entire part of the cable CA may be removed from the arm 20, or the part of the cable CA may be disposed within the arm 20.

When the cable CA is wound around the pins 43, deformation of the cable CA in the restoring direction is restricted by the pair of walls 41. In this manner, as inflation of the cable CA is restricted by the pair of walls 41, it is possible to easily attach the cable-length adjustment member 40 to the arm member 22 after adjustment of the length of the cable CA is finished.

As described above, in this embodiment, the cable-length adjustment member 40 may be removed from the arm member 22. Therefore, it is possible to adjust the length of the cable CA by the cable-length adjustment member 40, in a state in which the cable-length adjustment member 40 is removed from the arm member 22. Therefore, even when the cable CA is thick and thus it is not easy to bend the cable CA, it is possible to facilitate the adjusting operation of the length of the cable CA as compared to the case in which the cable CA is bent within the arm member 22.

By employing this configuration, the cable CA of the same length may be used for the different robot with the arm member 22 of different lengths but using the same electrical power lines and the same signal lines. In other words, it is possible to determine whether to use the cable-length adjustment member 40 or not according to the type of the robot. Moreover, it is possible to change an amount of adjustment of the cable-length adjustment member 40 according to the type of the robot.

It should be noted that the part of the cable CA may be contained within the cable-length adjustment member 40, in a state in which the cable-length adjustment member 40 is attached to the arm member 22. In this case, in the state in which the cover 46 of the cable-length adjustment member 40 is removed, the part of cable CA is pulled out through the hole 22b of the arm member 22. Then, the part of the cable CA that has been pulled out is contained within the cable-length adjustment member 40.

Further, in this embodiment, the cable-length adjustment member 40 is attached at the predetermined position along the outer periphery surface of the arm member 22, and at the predetermined position along the outer periphery surface of the arm member 22, the hole 22b that can be used for the wiring operation within the arm member 22 is defined.

According to this configuration, when the length of the cable CA contained within the arm member 22 is adjusted, a part of the cable CA within the arm member 22 is arranged within the cable-length adjustment member 40 attached to the outer periphery surface of the arm member 22. In other words, it is necessary to pull the part of the cable CA arranged within the arm member 22 outside the arm member 22. According to the second embodiment, at the position of the arm member 22 to which the cable-length adjustment member 40 is attached, the hole 22b that can be used for the wiring operation within the arm member 22 is provided. The size of the hole 22b for the wiring operation is such that a human hand can get into the hole. Therefore, it is possible to fully use the hole in order to pull the part of the cable CA arranged within the arm member 22b out of the arm member 22.

On the other hand, if the robot 2 is used without closing the hole 22b for the wiring operation, dust and the like may enter the arm member 22 through the hole 22b. The dust entering the arm member 22 may be a cause of damages to the cable CA within the arm member 22, damages to and functional deterioration of a sealing member within the arm member 22, damages to and functional deterioration of other components within the arm member 22, and the like. In this embodiment, an entire part of the hole 22b is closed by the cable-length adjustment member 40. Therefore, it is possible to reduce or prevent entrance of dust and the like into the arm member 22. Here, a part of the hole 22b may be closed by the cable-length adjustment member 40. In this case, it is also possible to reduce entrance of dust and the like into the arm member 22.

It should be noted that, in this embodiment, the pins 43 are rotatable with respect to the connecting member 42. For example, two spindles 43a are fixed to the connecting member 42, and the pins 43 are respectively supported by the spindles 43a using bearings. With this, each of the pins 43 is rotatable around its central axis line.

If there are the pins 43 fixed between the pair of walls 41 when the cable CA is contained between the pair of walls 41 while the cable CA is bent, the pins 43 often serve a resisting force during a containing operation. This tendency is shown, in particular, when the cable CA is thick and therefore it is not easy to bend the cable CA. If the pins 43 are rotatable, it is possible to reduce the resisting force when the cable CA is contained between the pair of walls 41 while the cable CA is bent.

Here, as illustrated in FIG. 9, the cable-length adjustment member 40 may include a pin-interval adjustment mechanism 44 as in the first embodiment. The pin-interval adjustment mechanism 44 shown in FIG. 9 includes a slider 44a to which the spindle 43a of one of the pins 43 is fixed, and a biasing member 44b such as a spring that biases the slider 44a in a direction in which the pins 43 are disposed side by side. The one pin 43 is disposed at a position more distant from the arm member 22 than the other of the pins 43. According to this configuration, if a force toward the other pin 43 is applied to the one pin 43, the one pin 43 moves toward the other pin 43.

Further, as illustrated in FIG. 9, the cable-length adjustment member 40 may be provided with a pin-interval adjustment mechanism 47 that allows the pins 43 to move toward the arm member 22 when a force directed toward the arm member 22 is applied to the pins 43. The pin-interval adjustment mechanism 47 includes a slider 47a to which the spindle 43a of the other of the pins 43 is fixed, and a biasing member 47b such as a spring that biases the slider 47a in a direction away from the arm member 22. The other pin 43 is disposed at a position closer to the arm member 22 than the one pin 43.

There is the case in which, after the cable-length adjustment member 40 is attached to the arm member 22, the length of the cable CA is slightly adjusted by pulling the cable CA disposed outside the cable-length adjustment member 40. In the configuration illustrated in FIG. 9, one of the pins 43 is supported movably toward the other of the pins 43, and this configuration is advantageous in order to facilitate the slight adjustment.

Here, in the configuration illustrated in FIG. 9, the two pins 43 are supported movably toward the arm member 22. This configuration is also advantageous in order to facilitate the slight adjustment.

It should be noted that in various embodiments, the cable-length adjustment member 40 may be attached to the arm member 21, 23, 24, 25, or 26, in place of the arm member 22. In particular, as the arm members 21 and 23 are disposed on the base-end side of the arm 20, the number of the electrical power lines and the signal lines passing therethrough is larger than that for the arm members 24, 25, and 26 on the tip-end side of the arm 20. Therefore, restricting deformation of the cable CA in the restoring direction by the pair of walls 41 facilitates the adjusting operation of the length of the cable CA.

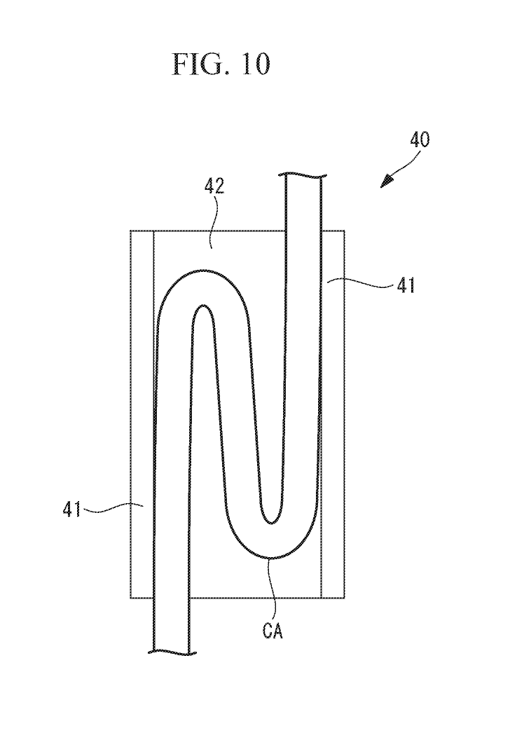

Further, in the various embodiments, it is not necessary to provide the pins 43 for the cable-length adjustment member 40. In this case, the cable CA is pushed in a space between the pair of walls 41. Moreover, as illustrated in FIG. 10, the cable CA may be contained by bending the cable CA, instead of winding the cable CA. Furthermore, the cable CA may be contained by winding the cable CA helically around the arm member 22 in a longitudinal axis line in a spiral manner.

Further, the cable CA as a bundle of the plurality of electrical power lines and signal lines may be divided into a plurality of bundles, and then the bundles are wound within the cable-length adjustment member 40.

Moreover, in the various embodiments, the robots 1 and 2 may be another type of robots. For example, the robots 1 and 2 may be of a horizontal articulated type. In this case, it is also possible to obtain the same effect as described above, by using the cable-length adjustment member 40 for an arm member that constitutes the robot 1 or 2.

From the above-described embodiments, the following aspects of the present disclosure are derived.

A robot according to one aspect of the present disclosure is provided with: an arm member; and a cable-length adjustment member configured to adjust length of a cable contained within the arm member, wherein the cable-length adjustment member is removably attached to the arm member.

According to this aspect, the cable-length adjustment member may be removed from the arm member. Therefore, it is possible to adjust the length of the cable by the cable-length adjustment member, in a state in which the cable-length adjustment member is removed from the arm member. Accordingly, even when the cable is thick and thus it is not easy to bend the cable, it is possible to facilitate an adjusting operation of the length of the cable as compared to a case in which the cable is bent within the arm member.

By employing this configuration, the cable of the same length may be used for various types of robots having the arm member of different lengths but using the same electrical power lines and the same signal lines. In other words, it is possible to determine whether to use the cable-length adjustment member or not according to the type of the robot. Moreover, it is possible to change an amount of adjustment of the cable-length adjustment member according to the type of the robot.

In this aspect, preferably, the cable-length adjustment member contains the cable that is bent, and includes a pair of walls that restrict deformation of the cable in a restoring direction against the bending.

According to this configuration, the pair of walls restrict deformation of the cable in the restoring direction. Therefore, even when the cable is required to be bent at a curvature radius from several centimeters to more than ten centimeters in order to adjust the length by more than ten centimeters to several tens of centimeters, the presence of the pair of walls may facilitate an operation for the bending.

In this aspect, preferably, the cable-length adjustment member is contained within the arm member.

As described above, by using the pair of walls, the cable may be easily bent within the cable-length adjustment member. It is also possible to contain the cable-length adjustment member within the arm member after the cable within the cable-length adjustment member is bent outside the arm member. This configuration is advantageous in order to facilitate the adjusting operation of the length of the cable.

In this aspect, preferably, the cable-length adjustment member is attached at a predetermined position on an outer periphery surface of the arm member, and a hole provided at the predetermined position of the outer periphery surface of the arm member, wherein the hole is for a wiring operation within the arm member.

According to this configuration, when the length of the cable contained within the arm member is adjusted, a part of the cable within the arm member is arranged within the cable-length adjustment member attached to the outer periphery surface of the arm member. In other words, it is necessary to pull the part of the cable arranged within the arm member outside the arm member. In this aspect, at the position of the arm member to which the cable-length adjustment member is attached, the hole that can be used for the wiring operation within the arm member is provided. The size of the hole for the wiring operation is such that a human hand can get into the hole. Therefore, it is possible to fully use the hole in order to pull the part of the cable arranged within the arm member out of the arm member.

On the other hand, if the robot is used without closing the hole for the wiring operation, dust and the like may enter the arm member through the hole. The dust entering the arm member may be a cause of damages to the cable within the arm member, damages to and functional deterioration of a sealing member within the arm member, damages to and functional deterioration of other components within the arm member, and the like. In this aspect, an entire part of the hole for the wiring operation is closed by the cable-length adjustment member. Therefore, it is possible to reduce or prevent dust and the like from entering into the arm member.

In this aspect, preferably, the cable-length adjustment member includes a connecting member configured to connect the pair of walls, and at least one pin that is provided on the connecting member and around which the cable is wound.

According to this configuration, there is the pin around which the cable is wound, and therefore the adjusting operation of the length of the cable may be facilitated as compared to a case in which there is no pin.

In this aspect, preferably, the pin is rotatable with respect to the connecting member.

If there is the pin fixed between the pair of walls when the cable is contained between the pair of walls while the cable is bent, the pin often serves a resisting force while containing. This tendency is shown, in particular, as described above, when the cable is thick and therefore it is not easy to bend the cable. In this aspect, the pin is rotatable. Therefore, it is possible to reduce the resisting force when the cable is contained between the pair of walls while the cable is bent.

In this aspect, preferably, the connecting member includes two pins, the cable-length adjustment member includes a pin-interval adjustment mechanism configured to support at least one of the two pins movably toward the other of the two pins.

There is a case in which the length of the cable is slightly adjusted by pulling the cable disposed outside the cable-length adjustment member after the cable-length adjustment member is attached to the arm member. In this aspect, one of the two pins is supported movably toward the other of the pins, and this configuration is advantageous in order to facilitate the slight adjustment.

According to aforementioned aspects, it is possible to facilitate an adjusting operation of a length of a cable contained within an arm member.

### REFERENCE SIGNS LIST

1, 2 Robots
10 Base portion
20 Arm
21-26 Arm members
21a-26a Servo motors
30 Controller
40 Cable-length adjustment member
41 Wall
42 Connecting member
43 Pin
44, 47 Pin-interval adjustment mechanisms
45 End wall
46 Cover

1. A robot comprising:
an arm member; and
a cable-length adjustment member configured to adjust length of a cable contained within the arm member, wherein
the cable-length adjustment member is removably attached to the arm member.

2. The robot according to claim 1, wherein
the cable-length adjustment member contains the cable that is bent, and includes a pair of walls that restrict deformation of the cable in a restoring direction against the bending.

3. The robot according to claim 1, wherein
the cable-length adjustment member is contained within the arm member.

4. The robot according to claim 1, wherein
the cable-length adjustment member is attached at a predetermined position on an outer periphery surface of the arm member, and
a hole is provided at the predetermined position of the outer periphery surface of the arm member, wherein the hole is for a wiring operation within the arm member.

5. The robot according to claim 2, wherein
the cable-length adjustment member includes a connecting member configured to connect the pair of walls, and at least one pin that is provided on the connecting member and around which the cable is wound.

6. The robot according to claim 5, wherein
the pin is rotatable with respect to the connecting member.

7. The robot according to claim 5, wherein
the connecting member includes two pins,
the cable-length adjustment member includes a pin-interval adjustment mechanism configured to support at least one of the two pins movably toward the other of the two pins.
